(19) United States
(12) Patent Application Publication
(10) Pub. No.: US 2021/0012300 A1
(43) Pub. Date: Jan. 14, 2021

(54) INFORMATION PROCESSING SYSTEM, INFORMATION PROCESSING METHOD, AND STORAGE MEDIUM

(71) Applicant: NEC Corporation, Minato-ku, Tokyo (JP)

(72) Inventors: Jun UCHIMURA, Tokyo (JP); Hiroshi TAKAHASHI, Kanagawa (JP)

(73) Assignee: NEC Corporation, Minato-ku, Tokyo (JP)

(21) Appl. No.: 16/980,629

(22) PCT Filed: Mar. 1, 2019
(86) PCT No.: PCT/JP2019/007987

§ 371 Date: Sep. 14, 2020

(30) Foreign Application Priority Data
Mar. 20, 2018 (JP) 2018-051936

(51) Int. Cl. G06Q 20/12; G06K 9/32; G06K 9/00

(52) U.S. Cl. CPC G06Q 20/12; G06K 9/0063; G06K 9/00201; G06K 9/3241

(57) ABSTRACT

Provided is an information processing system including: a detection means for, based on a shape of an object carried in by a customer, detecting a carrying-in form of a product to be purchased by the customer; and a notification information generation means for generating notification information used for providing a notification in accordance with the carrying-in form to the customer.

### TECHNICAL FIELD

The present invention relates to an information processing system, an information processing method, and a storage medium.

### BACKGROUND ART

Patent Literature 1 discloses a self-service checkout terminal that enables a customer to perform self-service checkout. The self-service checkout terminal has a function of displaying, on a screen, an instruction for the customer to perform product registration. Specifically, the self-service checkout terminal displays an instruction for the customer to place a basket on a stage on a screen.

### CITATION LIST

### Patent Literature

PTL 1: Japanese Patent Application Laid-open No. 2007-233828

### SUMMARY OF INVENTION

### Technical Problem

In the self-service checkout terminal disclosed in Patent Literature 1, the expected procedure is that a customer puts a product in a basket, carries in the basket, and performs checkout. As a form in which a customer carries in a product, however, a form other than a basket such as a cart, a bag, or the like is also expected. Patent Literature 1 does not provide any specific disclosure with respect to product registration for such a case.

The present invention has been made in view of the problem described above and intends to provide an information processing system, an information processing method, and a storage medium for supporting product registration that copes with various carrying-in forms.

### Solution to Problem

According to one example aspect of the present invention, provided is an information processing system including: a detection means for, based on a shape of an object carried in by a customer, detecting a carrying-in form of a product to be purchased by the customer; and a notification information generation means for generating notification information used for providing a notification in accordance with the carrying-in form to the customer.

According to another example aspect of the present invention, provided is an information processing method including: based on a shape of an object carried in by a customer, detecting a carrying-in form of a product to be purchased by the customer; and generating notification information used for providing a notification in accordance with the carrying-in form to the customer.

According to another example aspect of the present invention, provided is a storage medium storing a program that causes a computer to perform: based on a shape of an object carried in by a customer, detecting a carrying-in form of a product to be purchased by the customer; and generating notification information used for providing a notification in accordance with the carrying-in form to the customer.

### Advantageous Effects of Invention

According to the present invention, it is possible to provide an information processing system, an information processing method, and a storage medium for product registration support that copes with various carrying-in forms.

### BRIEF DESCRIPTION OF DRAWINGS

FIG. 1 is a block diagram illustrating a general configuration of a Point Of Sales (POS) system according to a first example embodiment.

FIG. 2 is a schematic top view illustrating the arrangement in the POS system according to the first example embodiment.

FIG. 3 is a schematic side view illustrating the arrangement in the POS system according to the first example embodiment.

FIG. 4 is a block diagram illustrating a hardware configuration example of an information processing system according to the first example embodiment.

FIG. 5 is a function block diagram of the information processing system according to the first example embodiment.

FIG. 6 is a flowchart illustrating an outline of a process performed by the information processing system according to the first example embodiment.

FIG. 7 is a schematic top view illustrating an example of display of a projection image in a POS system according to the first example embodiment.

FIG. 8 is a schematic top view illustrating an example of display of a projection image in the POS system according to the first example embodiment.

FIG. 9 is a schematic top view illustrating an example of display of a projection image in the POS system according to the first example embodiment.

FIG. 10 is a schematic top view illustrating an example of display of a projection image in the POS system according to the first example embodiment.

FIG. 11 is a schematic top view illustrating an example of display of a projection image in the POS system according to the first example embodiment.

FIG. 12 is a function block diagram of an information processing system according to a second example embodiment.

### DESCRIPTION OF EMBODIMENTS

Exemplary example embodiments of the present invention will be described below with reference to the drawings. In the drawings, the same components or corresponding components are labeled with the same reference symbols, and the description thereof may be omitted or simplified.

### First Example Embodiment

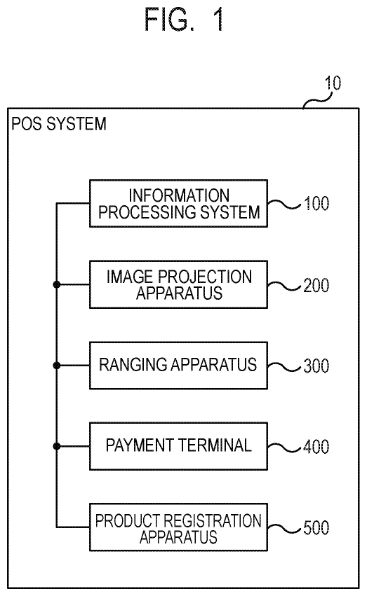

FIG. 1 is a block diagram illustrating a general configuration of a POS system 10 according to the present example embodiment. The POS system 10 is a system that performs registration of a product, payment, or the like for sales of a product or the like in a shop. The POS system 10 includes an information processing system 100, an image projection apparatus 200, a ranging apparatus 300, a payment terminal 400, and a product registration apparatus 500. The information processing system 100, the image projection apparatus 200, the ranging apparatus 300, the payment terminal 400, and the product registration apparatus 500 are connected to each other so as to be able to communicate with each other by a wired or wireless manner. Note that the POS system 10 may be used for payment of the price for a provided service.

The information processing system 100 is a computer, for example, and performs processing of control of each apparatus forming the POS system 10, acquisition of information from each apparatus, analysis of acquired information, or the like. The image projection apparatus 200 is an apparatus such as a transmission type liquid crystal projector, a reflection type liquid crystal projector, or the like and displays an image such as a text, a figure, a symbol, a picture, or the like on an object by emitting a light beam.

The ranging apparatus 300 may be an apparatus such as a stereo camera device, a Light Detection and Ranging (LiDAR) device, or the like and can acquire a spatial distribution of the distance from the ranging apparatus 300 to a ranging target.

The payment terminal 400 is an apparatus that accepts payment for purchase of a product or the like. This payment may be payment by cash or may be payment by a credit card, a debit card, electronic money, or the like other than cash. To accept payment by cash, a card, or the like, the payment terminal 400 has a cash feeding port, an automatic change machine, a card reader, or the like. Further, the payment terminal 400 has a display device such as a liquid crystal display, an Organic Light Emitting Diode (OLED) display, or the like for display of payment information or the like.

The product registration apparatus 500 is an apparatus that registers a product to be purchased. An amount to be paid at the payment terminal 400 is automatically calculated in the payment terminal 400 in accordance with a registered product. Further, registered product information is stored in a database of the POS system 10 and used for stock management, calculation of proceeds, or the like. Note that the payment terminal 400 and the product registration apparatus 500 may be an integrated apparatus such as a POS register.

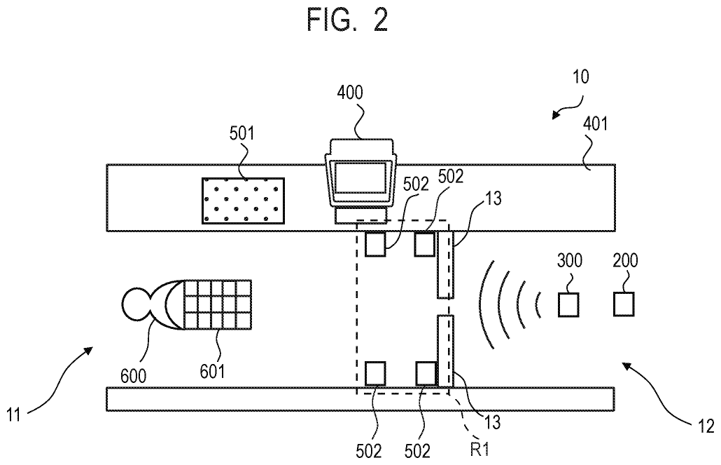

FIG. 2 is a schematic top view illustrating the arrangement of a lane in the POS system 10 according to the present example embodiment. The lane illustrated in FIG. 2 is a self-service type unmanned lane on which a customer 600 performs product registration, payment, or the like by himself/herself. The customer 600 who purchases a product holds a product and enters the lane from an entrance 11. In the example illustrated in FIG. 2, a product is loaded on a cart 601. However, a product may be put in a basket, a bag, or the like, or the customer 600 may hold a product in the hand. Once the customer 600 makes payment in the lane, gates 13 are operated to open, and the customer 600 may exit from an exit 12.

The payment terminal 400 is provided on a register stage 401. The register stage 401 forms a payment lane in a shop. Although FIG. 2 illustrates one payment terminal 400 and one register stage 401, each number thereof may be plural.

A wireless communication terminal 501 of the product registration apparatus 500 is provided on the register stage 401. The wireless communication terminal 501 is a wireless communication device such as a sheet-like antenna based on a Radio Frequency Identifier (RFID) technology, for example. Once the customer 600 places a product on the wireless communication terminal 501, the wireless communication terminal 501 communicates with an integrated circuit (IC) tag attached to a product and thereby acquires identification information on the product. Accordingly, the product registration apparatus 500 can register a product placed by the customer 600. Further, when the customer 600 puts a product in a basket and carries the basket in a payment lane, the customer 600 places the basket, which contains the product, on the wireless communication terminal 501, and thereby identification information on the product can be acquired. Note that, when a plurality of products are contained in a basket, the product registration apparatus 500 can collectively register all the products contained in the basket. In such a way, the wireless communication terminal 501 has a function of acquiring identification information used for product registration and may be referred to as an identification information acquisition apparatus in a more general sense.

Herein, the communication coverage area of the wireless communication terminal 501 is limited to a range above the wireless communication terminal 501, and the wireless communication terminal 501 does not communicate with a product outside the communication coverage area. Accordingly, erroneous registration of a product carried by another customer is suppressed.

Note that acquisition of identification information may be performed by using an optical reading device such as a scanner or the like to read a code attached to a package of a product or the like, such as a barcode, a two-dimensionally code, or the like. In such a case, the optical reading device is provided instead of the wireless communication terminal 501 on the register stage 401. The customer 600 may perform product registration by arranging the bringing product on the optical reading device or holding the bringing product above the optical reading device. Also in such a case, a product outside the readable area of the optical reading device is not read. Thus, a product held by another customer is not erroneously registered.

Further, at least one wireless communication terminal 502 adapted to the RFID technology is provided inside the lane. The wireless communication terminal 502 is a wireless communication device that, when the customer 600 carries in products by using the cart 601, performs product registration of the products in the cart 601 collectively. Accordingly, the customer 600 may complete payment without unloading the product from the cart 601. The wireless communication terminal 502 is an antenna device based on the RFID technology, for example. The wireless communication terminal 502 acquires identification information on each product in the cart 601 by wirelessly communicating with an IC tag attached to the product in the cart 601. Accordingly, the product registration apparatus 500 can register product loaded on the cart 601 by the customer 600. As described above, the wireless communication terminal 502 has a function of acquiring identification information used for a product registration in the same manner as the wireless communication terminal 501 and may be referred to as an identification information acquisition apparatus in a more general sense.

A communication coverage region R1 illustrated in FIG. 2 indicates a reading region where IC tags mounted on the cart 601 can be read from any of a plurality of wireless communication terminals 502. In the example of FIG. 2, four wireless communication terminals 502 are arranged to form a rectangle in order to secure a readable range corresponding to the shape of the cart 601.

Also in this case, the wireless communication terminal 502 does not communicate with a product outside the communication coverage region R1. This prevents erroneous registration of a product held by another customer.

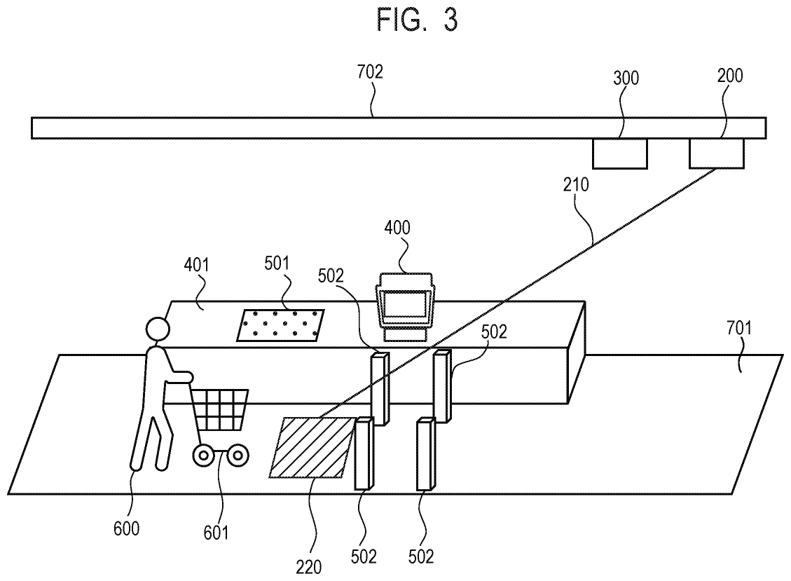

Herein, the configuration of the POS system 10 will be described in more detail with reference to FIG. 3 in addition. FIG. 3 is a schematic side view illustrating the arrangement of the lane in the POS system 10 according to the present example embodiment. Note that, in FIG. 3, illustration of the gate 13 is omitted.

The ranging apparatus 300 is arranged on a ceiling 702 of a shop. The ranging apparatus 300 performs ranging within a predetermined ranging range including the customer 600 or the cart 601 held by the customer 600. This ranging may be three-dimensional measurement to measure a distance in the depth direction while scanning two directions of the vertical direction and the horizontal directions, for example. In such a case, three-dimensional information within a ranging range can be obtained. Note that, when the ranging apparatus 300 is a LiDAR device, ranging accuracy in the depth direction can be improved compared to a case where a stereo camera or the like is employed. Although the type of a laser light source used for the LiDAR device is not particularly limited, the case where the laser light source is a laser light source that emits invisible light such as an infrared ray is more desirable because the ranging light does not give discomfort to the customer 600. The method of utilizing the information acquired by the ranging apparatus 300 will be described later.

The image projection apparatus 200 is also arranged on the ceiling 702 of the shop in the same manner as the ranging apparatus 300. The image projection apparatus 200 emits a light beam 210 to the floor surface 701 of the shop and thereby displays a projection image 220 on the floor surface 701. The image projection apparatus 200 has a mechanism that can change the orientation of emission of the light beam 210 within a predetermined range. Thereby, the image projection apparatus 200 can display the projection image 220 at a position in accordance with control of the information processing system 100. Note that, to enable the customer 600 to view the projection image 220, it is desirable that visible light be a main component of the light beam 210 emitted from the image projection apparatus 200. The projection image 220 may be an image for notifying the customer 600.

Once the product registration apparatus 500 acquires identification information, information such as a product name, a quantity of products, or a payment amount of payment target, a number of credit card or the like that can be used for payment, an operation instruction to the customer 600, or the like is displayed on the display device of the payment terminal 400.

Note that information related to a product of a payment target out of the displayed information can be acquired from a product database in the POS system 10 based on the identification information.

In response to the customer 600 completing payment using the payment terminal 400, the POS system 10 operates to open the gates 13. The customer 600 then carries a paid product and exits from the exit 12.

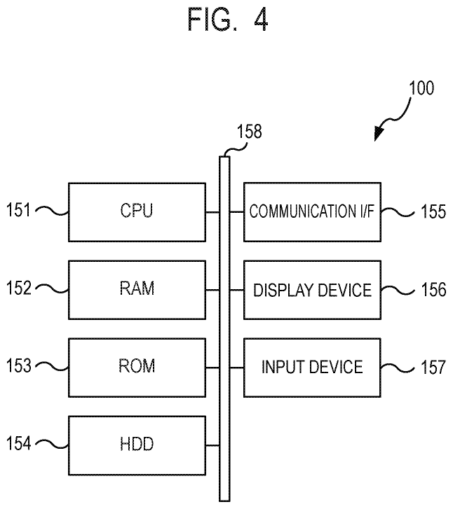

Next, the configuration and the operation of the information processing system 100 will be described. FIG. 4 is a block diagram illustrating an example of a hardware configuration of the information processing system 100. The information processing system 100 may be a computer, for example. The information processing system 100 may be a computer provided inside the image projection apparatus 200, the ranging apparatus 300, the payment terminal 400, or the product registration apparatus 500.

The information processing system 100 has a central processing unit (CPU) 151, a random access memory (RAM) 152, a read only memory (ROM) 153, and a hard disk drive (HDD) 154 as a computer that performs calculation, control, and storage. The information processing system 100 further has a communication interface (I/F) 155, a display device 156, and an input device 157. The CPU 151, the RAM 152, the ROM 153, the HDD 154, the communication I/F 155, the display device 156, and the input device 157 are connected to each other via a bus 158. Note that the display device 156 and the input device 157 may be connected to the bus 158 via a drive device (not illustrated) used for driving these devices.

While respective components forming the information processing system 100 are illustrated as an integrated device in FIG. 4, some of these functions may be provided by an external device. For example, the display device 156 and the input device 157 may be an external device independent of a part forming the function of a computer including the CPU 151 and the like.

The CPU 151 has a function of performing a predetermined operation in accordance with a program stored in the ROM 153, the HDD 154, or the like and also controlling each component of the information processing system 100. The RAM 152 is formed of a volatile storage medium and provides a temporary memory area necessary for the operation of the CPU 151. The ROM 153 is formed of a nonvolatile storage medium and stores necessary information such as a program used for the operation of the information processing system 100. The HDD 154 is a storage device that is formed of a nonvolatile storage medium and stores data required for processing, a program for operating the information processing system 100, or the like.

The communication I/F 155 is a communication interface based on the specification such as Ethernet (registered trademark), Wi-Fi (registered trademark), 4G, or the like, which is a module used for communicating with other devices. The display device 156 is a liquid crystal display, an OLED display, or the like and is used for displaying an image, a text, an interface, or the like. The input device 157 is a keyboard, a pointing device, or the like and is used by the user for operating the information processing system 100. An example of the pointing device may be a mouse, a trackball, a touch panel, or the like. The display device 156 and the input device 157 may be integrally formed as a touch panel.

Note that the hardware configuration illustrated in FIG. 4 is an example, and a device other than the above may be added, or some of the devices may not be provided. Further, some of the devices may be replaced with another device having the same function. Furthermore, a part of the function of the present example embodiment may be provided by another device via a network, or the function of the present example embodiment may be implemented by being distributed in a plurality of devices. For example, the HDD 154 may be replaced with a solid state drive (SSD) using a semiconductor memory or may be replaced with cloud storage.

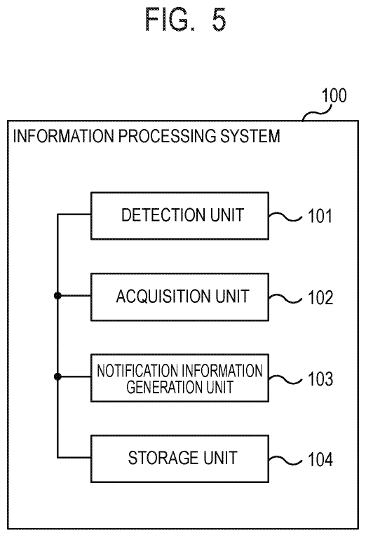

FIG. 5 is a function block diagram of the information processing system 100 according to the present example embodiment. The information processing system 100 has a detection unit 101, an acquisition unit 102, a notification information generation unit 103, and a storage unit 104.

The CPU 151 implements functions of the detection unit 101, the acquisition unit 102, and the notification information generation unit 103 by loading a program stored in the ROM 153, the HDD 154, or the like to the RAM 152 and executing the program. Processes performed in these units will be described later. The CPU 151 implements a function of the storage unit 104 by controlling the HDD 154.

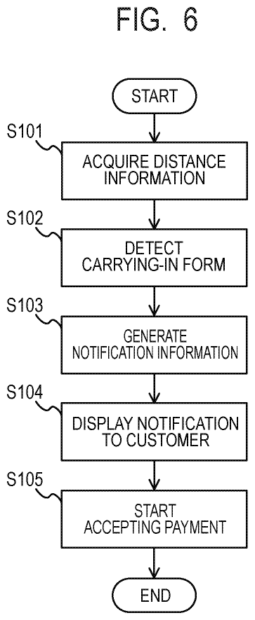

FIG. 6 is a flowchart illustrating a process performed by the information processing system 100 according to the present example embodiment. A payment-related process performed by the information processing system 100 will be described with reference to FIG. 6.

In step S101, the information processing system 100 instructs the ranging apparatus 300 to perform ranging within a predetermined range including the customer 600 or the cart 601 held by the customer 600. The ranging apparatus 300 performs ranging in response to this instruction. The distance information acquired by this ranging is transmitted to the information processing system 100 and stored in the storage unit 104 if necessary.

In step S102, the detection unit 101 acquires, from distance information obtained by the ranging apparatus 300, the shape of an object carried in by the customer 600 and detects a carrying-in form of a product to be purchased by the customer 600 based on the acquired shape. Herein, the article that is a detection target in this step carried in by the customer 600 may be, for example, the cart 601, a basket, a bag, the product itself, or the like. For example, when the shape of an object obtained by the ranging apparatus 300 is the cart 601, since it is expected that the customer 600 loads a product in the cart 601 and carries in the cart 601, the detection unit 101 detects that the carrying-in form is a form of the cart 601. Such detection of carrying-in form may be performed by using the three-dimensional shape data of an object carried in by the customer 600 as input and classifying the object into a predetermined category by using an object recognition technology, for example.

In step S103, the notification information generation unit 103 generates notification information used for displaying a notification in accordance with the carrying-in form to the customer 600. This notification information is supplied from the information processing system 100 to the image projection apparatus 200. This notification information may be, for example, data of a notification message included in a projection image 220 described later.

In step S104, the image projection apparatus 200 displays the projection image 220 based on the notification information generated by the notification information generation unit 103. It is desirable that a place to display the projection image 220 be a highly visible place near the customer 600, such as the floor surface 701 near the feet of the customer 600, for example.

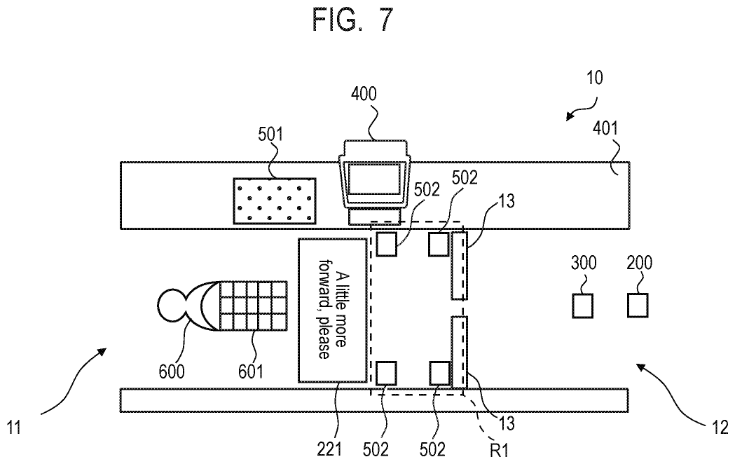

The content of a notification provided in the present example embodiment may be to urge the customer 600 to move a product to a place in accordance with the carrying-in form. Specific examples of the notification content will be described in more detail with reference to FIG. 7 to FIG. 10.

FIG. 7 is a schematic top view illustrating a display example of a projection image 221 when the carrying-in form is a form of the cart 601. As illustrated in FIG. 7, “A little more forward, please” is displayed in the projection image 221. That is, the projection image 221 is to urge the customer 600 to move the cart 601 to the inside of the communication coverage region R1 of the wireless communication terminal 502. In response to the customer 600 moving the cart 601 to the inside of the communication coverage region R1, the wireless communication terminal 502 communicates with an IC tag attached to the product in the cart 601 and is able to acquire identification information.

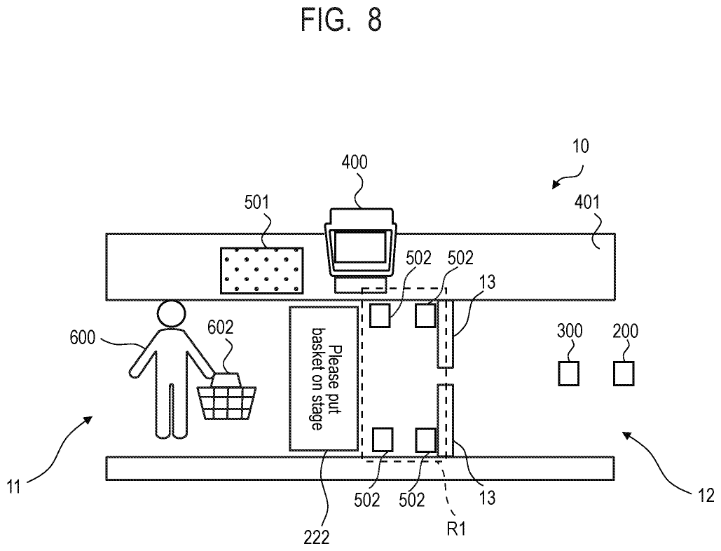

FIG. 8 is a schematic top view illustrating a display example of a projection image 222 when the carrying-in form is a form of a basket 602. As illustrated in FIG. 8, “Please put basket on stage” is displayed in the projection image 222. That is, the projection image 222 is to urge the customer 600 to move the basket 602 onto a reading stage of the wireless communication terminal 501. In response to the customer 600 moving the basket 602 onto the reading stage of the wireless communication terminal 501, the wireless communication terminal 501 communicates with an IC tag attached to the product in the basket 602 and is able to acquire identification information.

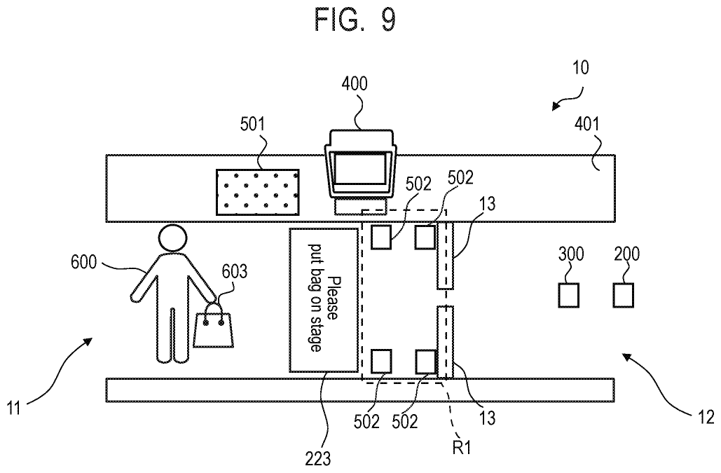

FIG. 9 is a schematic top view illustrating a display example of a projection image 223 when the carrying-in form is a form of a bag 603 such as a shopping bag. As illustrated in FIG. 9, “Please put bag on stage” is displayed in the projection image 223. That is, the projection image 223 is to urge the customer 600 to move the bag 603 onto a reading stage of the wireless communication terminal 501. In response to the customer 600 moving the bag 603 onto the reading stage of the wireless communication terminal 501, the wireless communication terminal 501 communicates with an IC tag attached to the product in the bag 603 and is able to acquire identification information.

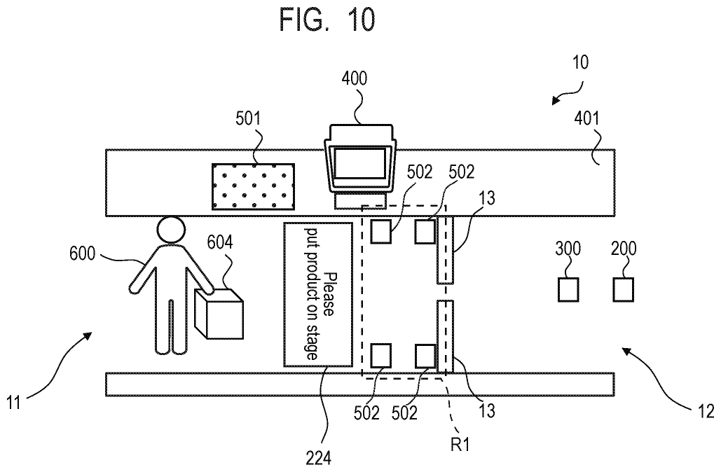

FIG. 10 is a schematic top view illustrating a display example of a projection image 224 when the customer 600 brings a product 604 alone without using the basket 602 or the like, that is, when the carrying-in form is a form of the product 604 alone. As illustrated in FIG. 10, “Please put product on stage” is displayed in the projection image 224. That is, the projection image 224 is to urge the customer 600 to place the product 604 on a reading stage of the wireless communication terminal 501. In response to the customer 600 placing the product 604 on the reading stage of the wireless communication terminal 501, the wireless communication terminal 501 communicates with an IC tag attached to the product 604 and is able to acquire identification information.

As described above, the notification information generation unit 103 generates notification information so that different notifications can be provided in accordance with a carrying-in form detected by the detection unit 101. Accordingly, it is possible to perform acquisition of identification information by causing a customer to move a product to a place suitable for a carrying-in form.

In step S105, the information processing system 100 controls the payment terminal 400 and the product registration apparatus 500 to enter a state where payment made by the customer 600 can be accepted. Accordingly, the customer 600 is able to start product registration using the product registration apparatus 500 and payment using the payment terminal 400. The acquisition unit 102 acquires the identification information acquired from the IC tag by the wireless communication terminal 501 or the wireless communication terminal 502. The identification information is used for product registration, and information on the registered product is used for calculation of a payment amount performed in the payment terminal 400.

As described above, even when various carrying-in forms of a product are employed, it is possible to provide an appropriate notification to the customer 600 in accordance with a carrying-in form. Therefore, according to the present example embodiment, the information processing system 100 for supporting product registration that copes with various carrying-in forms is provided.

Note that the information processing system 100 of the present example embodiment is useful also in terms of the following. In the identification information acquisition apparatus such as an optical reading device such as a wireless communication terminal, a scanner, or the like based on the RFID or the like, the detection range is limited in terms of the nature of a technology to be used, prevention of erroneous registration, or the like. Thus, with such an apparatus alone, it is neither easy to detect the carrying-in form of a product nor easy to provide a notification in accordance with the carrying-in form. In contrast, in the present example embodiment, since a ranging apparatus or the like are used to recognize the carrying-in form of a product from an apparatus other than the apparatus that acquires identification information, it is possible to compensate the limited detection range of the apparatus that acquires identification information.

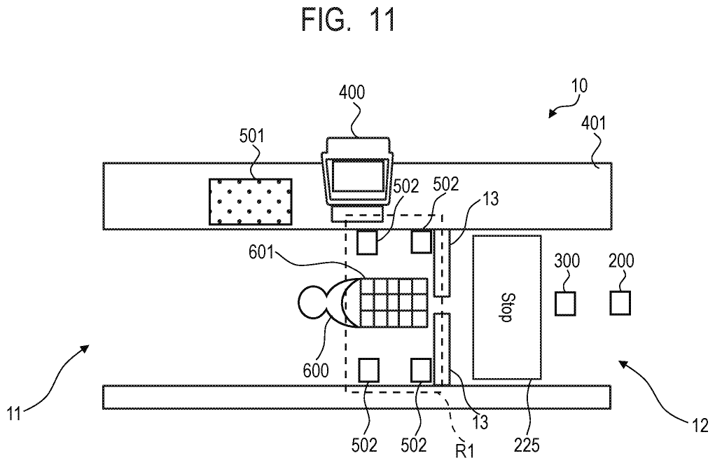

Note that the notification information generation unit 103 may further generate notification information used for providing a notification other than the notification that urges the customer to move a product to a place suitable for acquiring identification information as described above. For example, as a projection image 225 illustrated in FIG. 11 displays “Stop”, the content of a notification may be to ask the customer 600 to maintain the position of the cart 601 inside the communication coverage region R1. Such a notification may be provided when it is determined from distance information obtained by the ranging apparatus 300 that the cart 601 is already inside the communication coverage region R1. Similarly, the content of a notification may be a content that, when it is determined that the basket 602 is already above the wireless communication terminal 501, asks the customer 600 to maintain the state. A notification message in such a case may be, for example, “Please do not move basket until completion of product registration”.

The system described in the above example embodiment can also be configured as the following second example embodiment.

### Second Example Embodiment

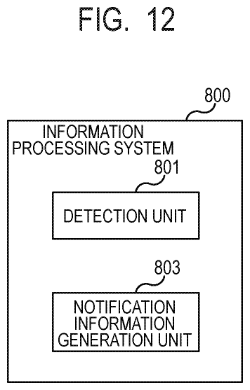

FIG. 12 is a function block diagram of an information processing system 800 according to the second example embodiment. The information processing system 800 has a detection unit 801 and a notification information generation unit 803. The detection unit 801 detects a carrying-in form of a product to be purchased by a customer based on a shape of an object carried in by the customer. The notification information generation unit 803 generates notification information used for providing a notification to the customer in accordance with the carrying-in form.

According to the present example embodiment, the information processing system 800 for supporting product registration that copes with various carrying-in forms is provided.

### Modified Example Embodiment

The present invention is not limited to the example embodiments described above and can be changed as appropriate without departing from the spirit of the present invention.

In the example embodiments described above, the ranging apparatus 300 may be replaced with an apparatus that does not perform ranging, such as a still camera, a video camera, or the like. In such a case, it is possible to calculate a distance between the payment terminal 400 and an approaching person from a captured image by using various image analysis technologies and perform the same process based on the calculated distance. However, it is more desirable to employ the ranging apparatus 300 that can directly measure a distance.

Further, in the example embodiments described above, the means that provides a notification is not limited to the image projection apparatus 200. For example, a notification may be displayed on a display device provided to the payment terminal 400 or the like, or a speaker provided to the payment terminal 400 or the like may be used to provide a notification by a voice.

Further, in the example embodiments described above, each content of the notification provided by the projection images 220 to 225 is not limited to a content of a sentence and may be a non-language content such as a figure, a symbol, a picture, or the like. For example, display indicating a place to put the basket 602 or the like may be provided with an arrow or the like.

The scope of each of the example embodiments also includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the program described above is stored but also the program itself. Further, one or two or more components included in the example embodiments described above may be a circuit such as an application specific integrated circuit (ASIC), a field programmable gate array (FPGA), or the like configured to implement the function of each component.

As the storage medium, for example, a floppy (registered trademark) disk, a hard disk, an optical disk, a magneto-optical disk, a compact disk (CD)-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

Further, a service implemented by the function of each of the example embodiments described above may be provided to a user in a form of Software as a Service (SaaS).

Note that all the example embodiments described above are mere embodied examples in implementing the present invention, and the technical scope of the present invention should not be construed in a limiting sense by these example embodiments. That is, the present invention can be implemented in various forms without departing from the technical concept thereof or the primary feature thereof.

The whole or part of the example embodiments disclosed above can be described as, but not limited to, the following supplementary notes.

### (Supplementary Note 1)

An information processing system comprising:

a detection means for, based on a shape of an object carried in by a customer, detecting a carrying-in form of a product to be purchased by the customer; and a notification information generation means for generating notification information used for providing a notification in accordance with the carrying-in form to the customer.

### (Supplementary Note 2)

The information processing system according to supplementary note 1, wherein the notification is to urge the customer to move the product to a place in accordance with the carrying-in form.

### (Supplementary Note 3)

The information processing system according to supplementary note 1 or 2, wherein when the carrying-in form is a form of a cart loaded with the product, the notification information generation means generates notification information used for urging the customer to move the cart to a reading region of an identification information acquisition apparatus used for product registration.

### (Supplementary Note 4)

The information processing system according to supplementary note 1 or 2, wherein when the carrying-in form is a form of a basket or a bag containing the product, the notification information generation means generates notification information used for urging the customer to move the basket or the bag onto a reading stage having an identification information acquisition apparatus used for product registration.

### (Supplementary Note 5)

The information processing system according to supplementary note 1 or 2, wherein when the carrying-in form is a form of the product alone, the notification information generation means generates notification information used for urging the customer to place the product on a reading stage having an identification information acquisition apparatus used for product registration.

### (Supplementary Note 6)

The information processing system according to any one of supplementary notes 3 to 5, wherein the identification information acquisition apparatus acquires identification information read from a storage medium included in the object by wireless communication.

### (Supplementary Note 7)

The information processing system according to any one of supplementary notes 1 to 6, wherein the detection means detects the carrying-in form based on distance information acquired by a ranging apparatus that acquires a distance to a ranging target.

### (Supplementary Note 8)

The information processing system according to supplementary note 7, wherein the ranging apparatus includes a Light Detection and Ranging (LiDAR) device.

### (Supplementary Note 9)

The information processing system according to supplementary note 8, wherein the LiDAR device includes a laser light source that emits invisible light.

### (Supplementary Note 10)

The information processing system according to any one of supplementary notes 1 to 9, wherein the notification information is supplied to an image projection apparatus that displays an image including the notification by emitting visible light.

### (Supplementary Note 11)

The information processing system according to supplementary note 10, wherein the image projection apparatus displays the image on a floor surface of a shop.

### (Supplementary Note 12)

The information processing system according to supplementary note 11, wherein the image projection apparatus displays the image near the customer.

### (Supplementary Note 13)

An information processing method comprising:

based on a shape of an object carried in by a customer, detecting a carrying-in form of a product to be purchased by the customer; and

generating notification information used for providing a notification in accordance with the carrying-in form to the customer.

### (Supplementary Note 14)

A storage medium storing a program that causes a computer to perform:

based on a shape of an object carried in by a customer, detecting a carrying-in form of a product to be purchased by the customer; and

generating notification information used for providing a notification in accordance with the carrying-in form to the customer.

This application is based upon and claims the benefit of priority from Japanese Patent Application No. 20186-051936, filed on Mar. 20, 2018, the disclosure of which is incorporated herein in its entirety by reference.

### REFERENCE SIGNS LIST

10 POS system
11 entrance
12 exit
13 gate
100, 800 information processing system
101, 801 detection unit
102 acquisition unit
103, 803 notification information generation unit
104 storage unit
151 CPU
152 RAM
153 ROM
154 HDD
155 communication I/F
156 display device
157 input device
158 bus
200 image projection apparatus
210 light beam
220 to 225 projection image
300 ranging apparatus
400 payment terminal
401 register stage
500 product registration apparatus
501, 502 wireless communication terminal
600 customer
601 cart
602 basket
603 bag
604 product
701 floor surface
702 ceiling
R1 communication coverage region

What is claimed is:

1. An information processing system comprising:
a detection unit that, based on a shape of an object carried in by a customer, detects a carrying-in form of a product to be purchased by the customer; and
a notification information generation unit that generates notification information used for providing a notification in accordance with the carrying-in form to the customer.

2. The information processing system according to claim 1, wherein the notification is to urge the customer to move the product to a place in accordance with the carrying-in form.

3. The information processing system according to claim 1, wherein when the carrying-in form is a form of a cart loaded with the product, the notification information generation unit generates notification information used for urging the customer to move the cart to a reading region of an identification information acquisition apparatus used for product registration.

4. The information processing system according to claim 1, wherein when the carrying-in form is a form of a basket or a bag containing the product, the notification information generation unit generates notification information used for urging the customer to move the basket or the bag onto a reading stage having an identification information acquisition apparatus used for product registration.

5. The information processing system according to claim 1, wherein when the carrying-in form is a form of the product alone, the notification information generation unit generates notification information used for urging the customer to place the product on a reading stage having an identification information acquisition apparatus used for product registration.

6. The information processing system according to claim 3, wherein the identification information acquisition apparatus acquires identification information read from a storage medium included in the object by wireless communication.

7. The information processing system according to claim 1, wherein the detection unit detects the carrying-in form based on distance information acquired by a ranging apparatus that acquires a distance to a ranging target.

8. The information processing system according to claim 7, wherein the ranging apparatus includes a Light Detection and Ranging (LiDAR) device.

9. The information processing system according to claim 8, wherein the LiDAR device includes a laser light source that emits invisible light.

10. The information processing system according to claim 1, wherein the notification information is supplied to an image projection apparatus that displays an image including the notification by emitting visible light.

11. The information processing system according to claim 10, wherein the image projection apparatus displays the image on a floor surface of a shop.

12. The information processing system according to claim 11, wherein the image projection apparatus displays the image near the customer.

13. An information processing method comprising:
based on a shape of an object carried in by a customer, detecting a carrying-in form of a product to be purchased by the customer; and
generating notification information used for providing a notification in accordance with the carrying-in form to the customer.

14. A non-transitory storage medium storing a program that causes a computer to perform:
based on a shape of an object carried in by a customer, detecting a carrying-in form of a product to be purchased by the customer; and
generating notification information used for providing a notification in accordance with the carrying-in form to the customer.
